(19) United States
(12) Patent Application Publication
(10) Pub. No.: US 2013/0124519 A1
(43) Pub. Date: May 16, 2013

(54) MEDICAL INFORMATION PROCESSING DEVICE

(71) Applicant: Yutaka UEDA, Tokyo (JP)

(72) Inventor: Yutaka UEDA, Tokyo (JP)

(21) Appl. No.: 13/676,699

(22) Filed: Nov. 14, 2012

(30) Foreign Application Priority Data
Nov. 15, 2011 (JP) 2011-249244

(51) Int. Cl. G06F 17/30

(52) U.S. Cl. CPC G06F 17/3028
USPC 707/736

(57) ABSTRACT

A medical information processing device includes a display portion which displays a chart information display screen, an operation portion for specifying an inspection item on the chart information display screen, an acquisition portion which acquires image data of an inspection image corresponding to the specified inspection item, and a controlling portion. The controlling portion sets the acquisition portion in a standby state for acquisition of the image data when the inspection item is specified by the operation portion, and when the image data was acquired by the acquisition portion, the controlling portion stores the acquired image data in a memory portion such that the image data is associated with chart information being displayed on the chart information display screen.

### BACKGROUND OF THE INVENTION

1. Field of the Invention

The present invention relates to a medical information processing device.

2. Description of Related Art

Recently, in a medical field, digitalization of medical inspection images obtained from a patient and medical information record (chart) prepared by a doctor is now being developed. When preparing a chart information (medical information record) by referring to a (medical) inspection image, a chart information display screen which displays chart information and an inspection image display screen which displays a (medical) inspection image are displayed side by side.

There is a case that, when preparing a chart information with referring to an inspection image, an inspection image displayed in the inspection image display screen is copied and pasted in the chart information display screen. A medical image system is disclosed which checks consistency between patient information tied to an inspection image and patient information of the chart information displayed on the chart information display screen to avoid mixing up the information with different patient's information (JP2009-211647A).

A system, which an inspection image display screen (image viewer screen) also serves as a console screen for a modality (equipment) such as a CR (Computed Radiography) device, is generally used in a small clinic. That is, image data of a medical inspection image generated by a modality is captured in a personal computer of a doctor and the inspection image is displayed on an inspection image display screen based on the captured image data.

In such a system, at first, a medical inspection item for a patient is determined on an operation screen. When an acquisition button for acquiring image data from a designated a modality corresponding to the specified inspection is pressed, the system is put into a standby (waiting) state for acquiring image data of an inspection image from the modality. Upon generation of image data of the inspection image at the modality, the generated image data is acquired in the personal computer as an image data of the patient.

On the other hand, in a large hospital, a doctor who examined a patient makes an inspection order for the patient and a technical staff takes medical inspection images at an examination room according to the inspection order. The image data of the inspection images are then stored such that the data is associated with information of the patient.

In a small clinic, a doctor examines a patient and the doctor performs a medical inspection for the patient. Therefore, another patient will not be examined after a medical inspection is ordered for the patient and before an image data of the patient is acquired. Therefore, there was no possibility that image data of a patient was accidentally acquired as that of a different patient.

However, even in a small clinic, when a medical inspection item was specified, an acquisition operation from a modality corresponding to the specified inspection has to be done. That causes a troublesome work for a user.

### SUMMARY OF THE INVENTION

The present invention was made in light of the above problem and it is an object of the present invention to improve operability for acquiring image data of a medical inspection image.

### MEANS TO SOLVE THE PROBLEMS

According to an aspect of the invention, a medical information processing device includes a display portion which displays a chart information display screen, an operation portion for specifying an inspection item on the chart information display screen, an acquisition portion which acquires image data of an inspection image corresponding to the specified inspection item, and a controlling portion.

The controlling portion sets the acquisition portion in a standby state for acquisition of the image data when the inspection item is specified by the operation portion and when the image data was acquired by the acquisition portion, the controlling portion stores the acquired image data in a memory portion such that the image data is associated with chart information displayed on the chart information display screen at a time of acquisition.

According to an aspect of the invention, it becomes possible to improve operability for acquiring image data of a medical inspection image.

When the image data was acquired by the acquisition portion of the above medical information processing device, preferably, the controlling portion of the device can display an inspection image on the display portion based on the acquired image data.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a system structure of a data management system,

FIG. 2 is a block diagram for explaining a functional structure of a data management server,

FIG. 3 is a block diagram for explaining a functional structure of a terminal device according to an embodiment of the present invention,

FIG. 4 is a flowchart executed at a terminal device according to an embodiment of the present invention,

FIG. 5 is an example of a medical information display screen for specifying a medical inspection item,

FIG. 6 is an example of a medical information display screen during acquisition of image data, and

FIG. 7 is an example of a medical information display screen after acquisition of image data.

### PREFERRED EMBODIMENT OF THE INVENTION

An exemplary embodiment of the invention will be explained with reference to the drawings.

### (Structure of Data Management System)

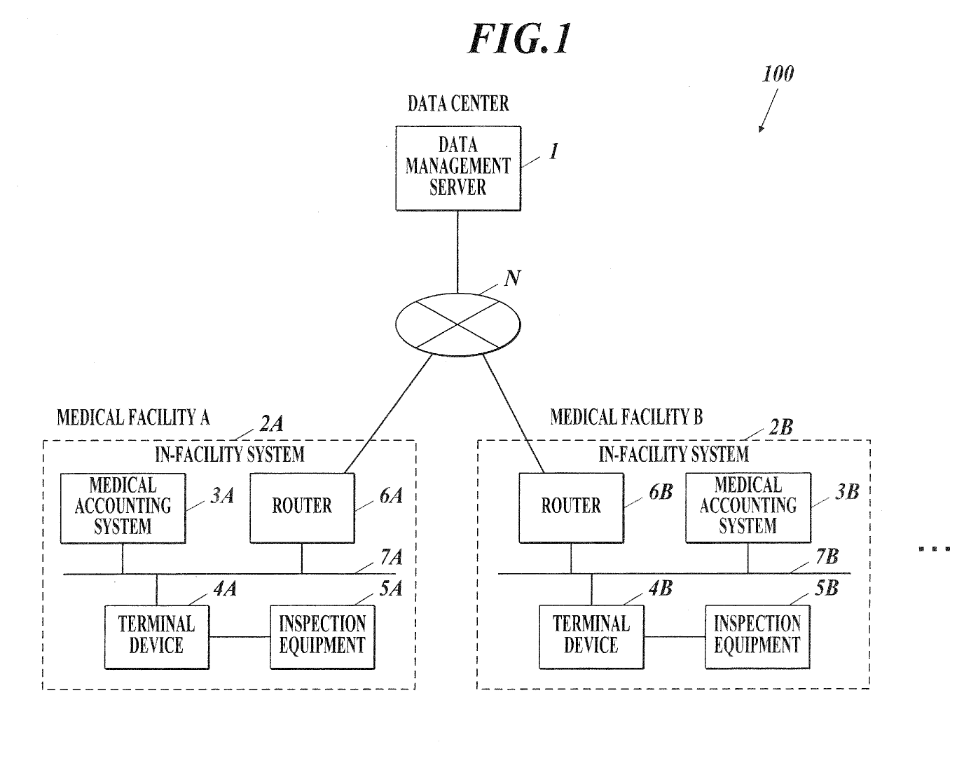

FIG. 1 shows a system structure of a data management system 100 including terminal devices 4A, 4B, and the like as medical information processing devices according to an exemplary embodiment of the present invention.

As shown in FIG. 1, the data management system 100 is composed of a data management server 1 placed at a regional data center, an in-facility system 2A located in a medical facility A, an in-facility system 2B located in a medical facility B, and the like. The data management server 1, in-facility system 2A, in-facility system 2B, and the like are linked so as to communicate with each other through a communication network N such as an Internet.

The data management server 1 stores and manages image data of medical inspection images generated in each of the medical facilities. The data management server 1 provides medical conjunction services between medical facilities. That is, the data management server 1 accepts a request, from the in-facility system 2A, 2B, or the like, of a medical inspection or an interpretation of an image at the other in-facility system and manages obtained data of inspection and interpretation results.

The in-facility system 2A is provided with a medical accounting system 3A, terminal device 4A, medical inspection device 5A and router 6A, and the medical accounting system 3A, terminal device 4A and router 6A are connected so as to data-communicate with each other via an in-facility network 7A such as a LAN (Local Area Network). At least the terminal device 4A, among the equipments constituting the in-facility system 2A, is connected to the data management server 1 so as to data-communicate with each other by the router 6A via the communication network N.

The in-facility system 2B is provided with a medical accounting system 3B, terminal device 4B, medical inspection device 5B and router 6B, and the medical accounting system 3B, terminal device 4B and router 6B are connected so as to data-communicate with each other via an in-facility network 7B such as a LAN. At least the terminal device 4B, among the equipments constituting the in-facility system 2B, is connected to the data management server 1 so as to data-communicate with each other by the router 6B via the communication network N.

The number of the in-facility systems 2A, 2B, and the like which constitute the data management system 100 and the number of equipments in the in-facility system are not limited thereto.

The DICOM (Digital Image and Communications in Medicine) standard is generally used as a communication system for the data management system 100. The DICOM MWM (Modality Worklist Management) or DICOM MPPS (Modality Performed Procedure Step) is used for the communication between the equipments

### (Structure of Data Management Server)

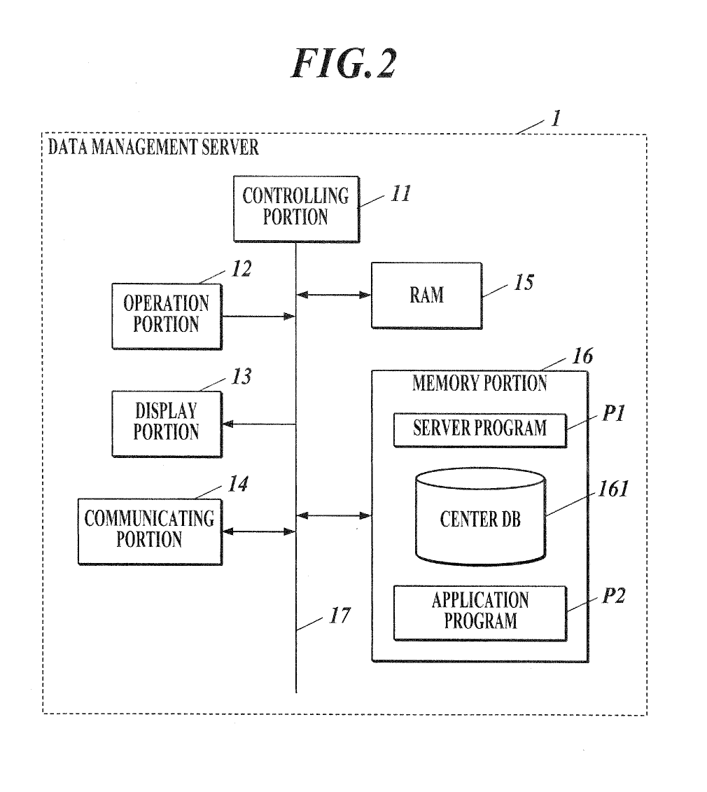

FIG. 2 shows a functional structure of the data management server 1.

As shown in FIG. 2, the data management server 1 is composed of a controlling portion 11, operation portion 12, display portion 13, communication portion 14, RAM 15, memory portion 16, and the like and the portions are connected with each other via a bus 17.

The controlling portion 11 is composed of a CPU (Central Processing Unit) and the like and can control each portion of the data management server 1. Specifically, the CPU reads various processing programs stored in the memory portion 16 and develops them in the RAM 15, in accordance with operation signals input from the operation portion 12 or command signals received by the communication portion 14, so as to perform various processes in cooperation with the programs.

The operation portion 12 is composed of a keyboard having a cursor key, numeric keys, various function keys, and the like and a pointing device such as a mouse and can output operation signals being input by a key operation or a mouse operation to the controlling portion 11.

The display portion 13 is composed of a monitor such as a LCD (Liquid Crystal Display) and can display various screens based on a command by display signals input from the controlling portion 11.

The communication portion 14 is composed of a network interface or the like and can transmit/receive data between outer equipments connected via the communication network N.

The RAM 15 can provide a working area for temporarily storing various programs, input/output data, parameters, and the like read from the memory portion 16 when the controlling portion 11 performs various processing.

The memory portion 16 is composed of a HDD (Hard Disk Drive), non-volatile memory, and the like and stores various programs and parameters and files for executing the programs. Specifically, the memory portion 16 stores a server program P1, center DB (DataBase) 161, application program P2, and the like.

The server program P1 is an execution program for data management processing in the data management server 1 and for providing the application program 92 and the medical conjunction services.

The center DB 161 stores patient basic information, chart information, image data of an inspection image and the like transmitted from the terminal devices 4A, 4b and the like of the medical facilities A, B and the like.

The patient basic information is information relating to a patient and includes a patient ID, name, age, sex, date of birth, date/time of consultation and the like. The patient basic information is obtained by the terminal devices 4A, 4b, and the like of the medical facilities A, B, and the like from the medical counting system 3A, 3B, and the like.

The chart information indicates progression of examination of a patient at each medical facility A, B, or the like and includes name of a disease, examination items, prescription information and the like. The chart information is created for every patient and for every examination.

The image data of an inspection image is image data obtained by an inspection of a patient at each medical facility A, B, or the like. The image data of an inspection image is stored by a DICOM file system which is based on the DICOM standard and supplementary information such as a patient ID, inspection ID, patient's name, inspection date/time, modality, and the like are attached.

The application program P2 is a SaaS (Software as a Service) type application which is downloaded as necessary when the terminal device 4A, 4B, or the like of the in-facility systems 2A, 2B, or the like accessed the data management server 1. The application program P2 is a program to realize an electronic chart generation function, image viewer function, and the like in the terminal devices 4A, 4B and the like.

Upon receiving the patient basic information, chart information, image data of an inspection image, and the like from the terminal devices 4A, 4b, and the like by virtue of the communication portion 14, the controlling portion 11 stores the information and the image data in the center DB 161 of the memory portion 16.

The controlling portion 11 accepts a request for a medical inspection and/or an interpretation of an image to a medical facility from another medical facility in the data management system 100 and notifies the inspection request and/or interpretation request to the facility. The controlling portion 11 obtains medical inspection data, report data of the image interpretation, and the like prepared in response to the request and provides the data to the facility that made the request.

(Structure of in-Facility System)

Next, each of the equipments which structure the in-facility system 2A will be explained.

The medical accounting system 3A is a computer device including a controlling portion, operation portion, display portion, communicating portion, RAM, memory portion, and the like and makes an accounting calculation, insurance points calculation, and the like.

The terminal device 4A is used for preparation of an electronic chart, acquiring image data of an inspection image from the inspection device 5A, referring to an inspection image, and the like.

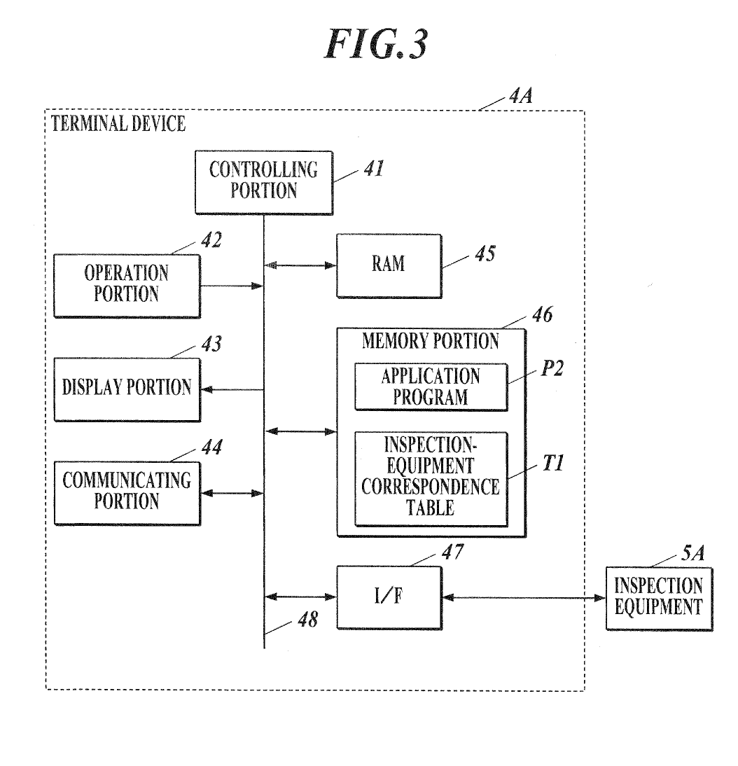

FIG. 3 shows a functional structure of the terminal device 4A.

The terminal device 4A is structured, as shown in FIG. 3, by a controlling portion 41, operation portion 42, display portion 43, communicating portion 44, RAM 45, memory portion 46, I/F 47, and the like and each portions are connected by a bus 48.

The controlling portion 41 is composed of a CPU and the like and controls processing operations of each portions of the terminal device 4A. Specifically, the CPU reads the processing programs stored in the memory portion 46 and develops them in the RAM 45 based on the operation signals input from the operation portion 42 or command signals received from the communicating portion 44 and executes various processing in cooperation with the programs.

The operation portion 42 is composed of a keyboard having a cursor key, numeric keys, various function keys, and the like and a pointing device such as a mouse and can output operational signals being input by a key operation of the keyboard or a mouse operation to the controlling portion 41. The controlling portion 42 is used, for example, for specifying an inspection item on a chart information display screen.

The display portion 43 is composed of a monitor such as a LCD and can display various screens based on a command of display signals input from the controlling portion 41. The display portion 43 can display, for example, a chart information display screen and an inspection image display screen of a patient.

The communication portion 44 is composed of a network interface or the like, and can transmit/receive data between outer equipment connected via the in-facility network 7A and the communication network N.

The RAM 45 can provide a working area for temporarily storing various programs, input/output data, parameters, and the like read from the memory portion 46 when the controlling portion 41 performs various processing.

The memory portion 46 is composed of a HDD, non-volatile memory, and the like and stores various programs and parameters and files for executing the programs. Specifically, the memory portion 46 stores such as an application program P2.

The memory portion 46 stores an inspection-equipment correspondence table T1. The inspection-equipment correspondence table T1 is a table in which a plurality of inspection items and an inspection equipment 5A used for each of the inspections are associated with each other.

The memory portion 46 stores chart information input from the terminal device 4A and image data of inspection images obtained by the inspection equipment 5A.

The I/F 47 is an acquiring portion which can acquire image data of inspection images of a patient obtained by the inspection equipment 5A.

When an inspection item in the chart information display screen is specified by the operation portion 42, the controlling portion 41 determines, in cooperation with the application program P2, the inspection equipment 5A corresponding to the specified inspection item by referring to the inspection-equipment correspondence table T1 stored in the memory portion 46. The controlling portion 41 transmits an inspection order to the specified inspection equipment 5A via the I/F 47 and makes the I/F 47 be in a standby state for acquisition of image data. The inspection order includes patient information such as a name of a patient, sex, age, length and weight and inspection conditions such as an imaged position and imaging direction.

Upon acquiring the image data from the inspection equipment 5A by the I/F 47, the controlling portion 41 stores the acquired image data in the memory portion 46 such that the image data is associated with the chart information displayed in the chart information display screen.

Upon acquiring the image data from the inspection equipment 5A by the I/F 47, the controlling portion 41 displays the inspection image on the inspection image data display screen of the display portion 43 based on the acquired image data.

Upon acquiring the image data from the inspection equipment 5A by the I/F 47, the controlling portion 41 generates thinned-out image data of the acquired image data and displays a thumbnail image on the chart information display screen based on the thinned-out image data.

The controlling portion 41 stores the thinned-out image data in the memory portion 46 such that the thinned-out image data is associated with the chart information displayed on the chart information display screen.

The controlling portion 41 controls the communicating portion 44 so as to transmit the chart information, image data of the inspection images and thinned-out image data stored in the memory portion 46 to the data management server 1 for storing the data in the center DB 161 of the data management server 1.

The inspection equipment 5A takes images of an inspection area of a patient to be examined and generates digital image data of the inspection images by digitally converting the acquired images. The inspection equipment 5A may be a CR (Computed Radiography), CT (Computed Tomography), MRI (Magnetic Resonance Imaging) and the like.

The number of the inspection equipment 5A connected to the terminal device 4A may be one or more (not limited).

An explanation of the in-facility system 2B and so on other than the in-facility system 2A is omitted because they have the same structure as that of the in-facility system 2A.

### (Operation of Data Management System)

An operation of the data management system 100 will be explained.

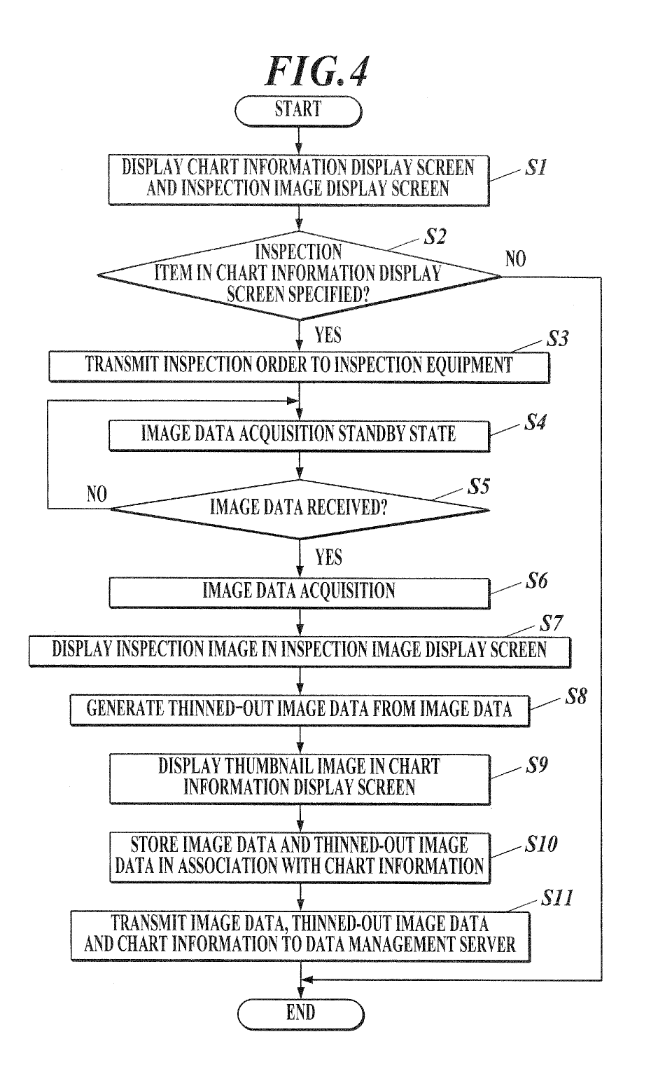

FIG. 4 shows a process flowchart executed by the terminal device 4A. The process is executed by the software processing in cooperation with the controlling portion 41 and the application program P2 stored in the memory portion 46.

At first, the controlling portion 41 displays a medical information display screen including the chart information display screen and the inspection image display screen on the display portion 43 (step S1).

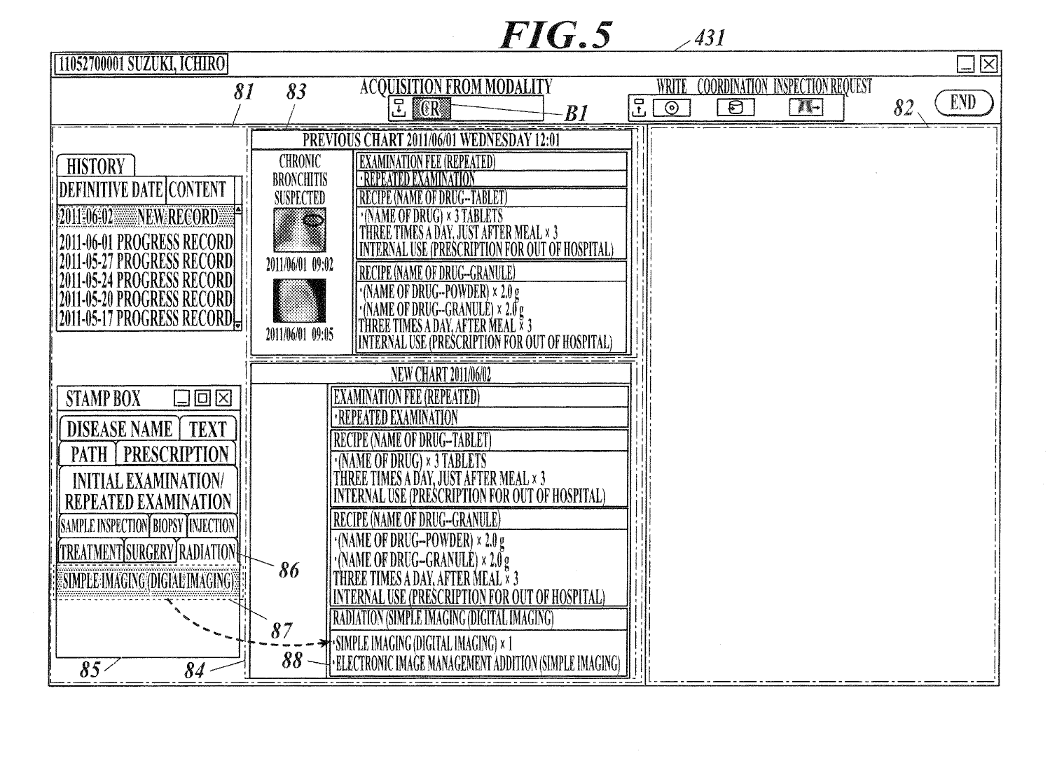

FIG. 5 is an example of the medical information display screen 431 displayed on the display portion 43.

The medical information display screen 431 includes the chart information display screen 81, inspection image display screen 82 and the like.

The chart information display screen 81 includes a previous chart information display screen 83, chart information inputting screen 84, stamp box 85 and the like. The previous chart information display screen 83 displays previous chart information. The chart information inputting screen 84 is for inputting chart information at this time. The stamp box 85 displays selectable stamps (item for which a drug price for insurance is priced in the medical accounting system 3A) for medical examinations and prescriptions for every categories. Each tab of the stamp box 85 indicates each category. It is possible to specify inspection items and prescriptions being frequently selected by drugging the stamp from the stamp box 85 and dropping it on the chart information inputting screen 84.

An inspection image of the patient, whose chart information is displayed on the chart information display screen 81, is displayed on the inspection image display screen 82 based on the image data of the inspection image acquired from the inspection equipment 5A.

Next, the controlling portion decides whether or not an inspection item is specified by an operation of the operation portion 42 by a user in the chart information display screen (step S2). Specifically, an inspection item is specified by selecting a stamp in the stamp box 85 corresponding to the inspection item, drugging and dropping on the chart information inputting screen 84 in the chart information display screen 81 of the medical information display screen 431 shown in FIG. 5.

When an inspection item is specified in the chart information display screen (step S2: YES), the controlling portion 41 refers to the inspection-equipment correspondence table T1 stored in the memory portion 46 and designates the inspection equipment 5A corresponding to the specified inspection item. The controlling portion 41 transmits an inspection order to the inspection equipment 5A through the I/F 47 (step S3), and the I/F 47 is set in a standby state for acquiring image data of an inspection image (step S4).

For example, when a stamp 87 of a “simple imaging (digital imaging)” in a radiation tab 86 of the stamp box 85 is drugged and dropped to the chart information inputting screen 84, an inspection content display region 88 captioned as “radiation (simple imaging (digital imaging))” is added in the chart information inputting screen 84 and items of “simple imaging (digital imaging)×1” and “electronic image management addition (simple imaging)” are displayed in the inspection content display region 88. In addition, an acquisition button B1 for acquiring images from a CR equipment (inspection equipment 5A) in the medical information display screen 431 is set in a pressed state. The acquisition button B1 is a command button for acquiring image data of an inspection image transmitted from the CR equipment as an image for the patient to be examined (the patient whose chart information is displayed on the chart information display screen 81).

The imaging of the patient based on the inspection order is performed by the inspection equipment 5A and the image data of the inspection images is generated. The image data is transmitted to the terminal device 4A from the inspection equipment 5A.

When image data is not received from the inspection equipment 5A (step S5: NO), the process goes back to step S4 and the standby state continues.

When image data is received from the inspection equipment 5A (step S5: YES), the image data is acquired from the inspection equipment 5A by the I/F 47 (step S6). The acquired image data is stored in the RAM 45 under the control of the controlling portion 41.

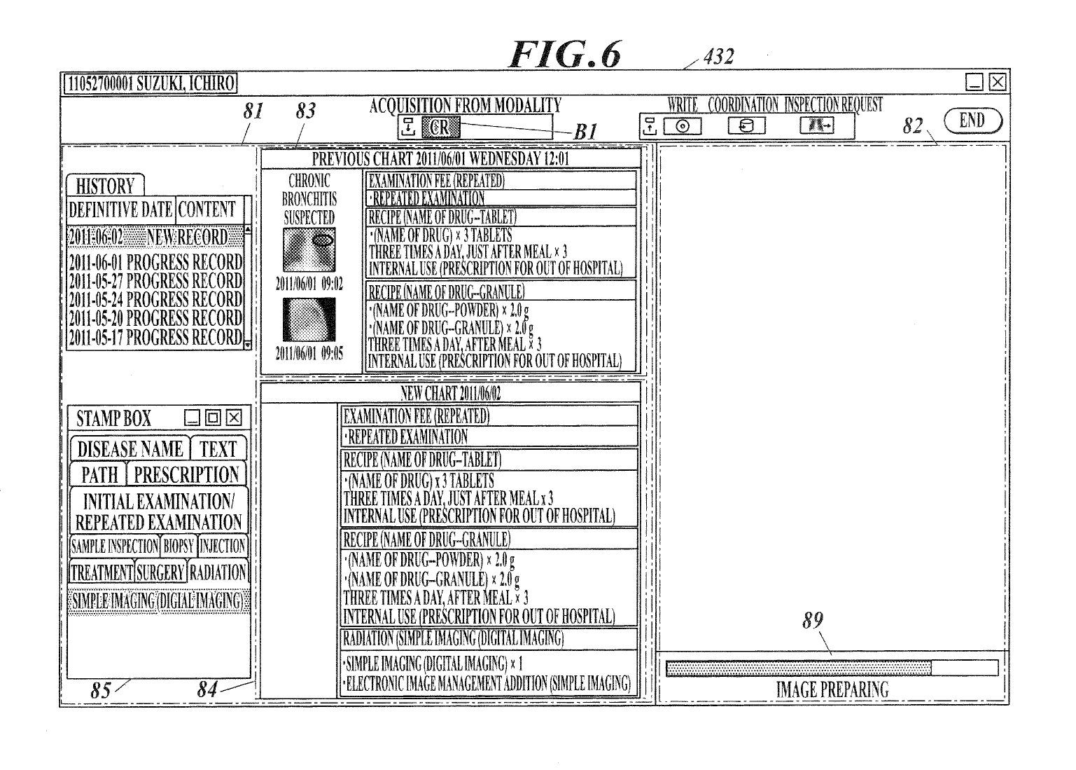

FIG. 6 is an example of a medical information display screen 432 which is displayed on the display portion 43 during the acquisition of the image data from the inspection equipment 5A. An acquisition rate of the image data is displayed at an acquisition state display region 89 in the inspection image display screen 82.

Next, the controlling portion 41 displays the inspection image in the inspection image display screen based on the image data acquired from the inspection equipment 5A (step S7).

Next, the controlling portion 41 thins out the image data acquired from the inspection equipment 5A so as to generate thinned-out image data (step S8). The generated thinned-out image data is stored in the RAM 45 by the controlling portion 41.

Next, the controlling portion 41 displays a thumbnail image on the chart information display screen based on the thinned-out image data (step S9).

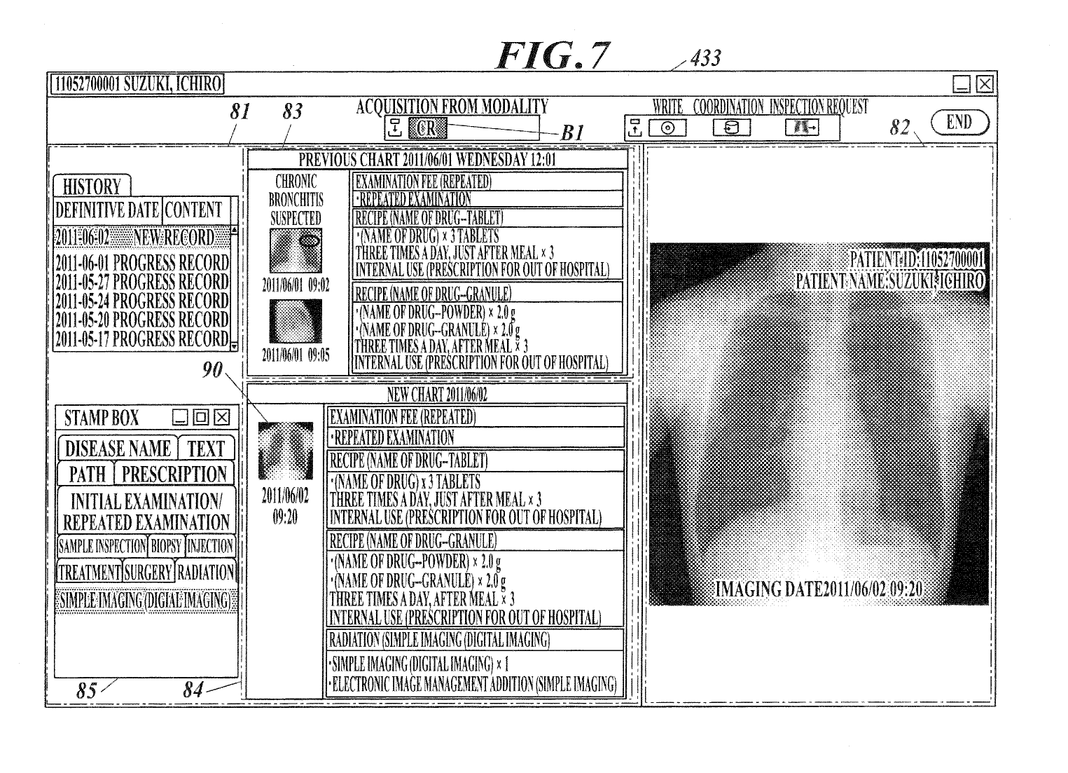

FIG. 7 is an example of a medical information display screen 433 displayed on the display portion 43. The inspection image based on the image data acquired from the inspection equipment 5A is displayed on the inspection image display screen 82. A thumbnail image display region 90 is added in the chart information inputting screen 84 of the chart information display screen 81 and a thumbnail image based on the thinned-out image data is displayed in the thumbnail image display region 90.

Next, the controlling portion 41 stores the image data of the inspection image acquired from the inspection equipment 5A and the thinned-out image data generated at step S8 in the memory portion 46 such that they are associated with the chart information displayed in the chart information display screen (step S10).

When determination of the chart information is commanded by the operation of the operation portion 42 by a user, the controlling portion 41 transmits the image data of the inspection image and the thinned-out image data, which are associated with the chart information, to the data management server 1 through the communication portion 44 (step S11).

The data management server 1 receives the image data of the inspection image, the thinned-out image data and the chart information from the terminal device 4A through the communication portion 14 and the controlling portion 11 stores the image data and the thinned-out image data, which are associated with the chart information, in the center DB 161 of the memory portion 16.

When the chart information is referred to, a thumbnail image is displayed in the chart information display screen and a high-resolution and finely-detailed image (an inspection image based on image data before thinning-out) is displayed upon clicking the thumbnail image.

When no inspection item is specified at step S2 (step S2: NO) or after step S11, the processing executed at the terminal device 4A is terminated.

The above explanation is related to the terminal device 4A; however, the same processing is executed at the terminal device 43.

As explained above, according to an embodiment of the present invention, by specifying an inspection item at the chart information display screen, the device of the invention is set in a standby state for acquisition of image data of an inspection image from an inspection equipment 5A, 5b, or the like corresponding to the specified inspection item. Thus it becomes not necessary to press a button for acquiring image data corresponding to an inspection equipment 5A, 5B, or the like, which was necessary for a conventional device.

According to an embodiment of the invention, when image data is acquired during a standby state for acquisition of image data of an inspection image, the acquired image data is stored in the memory portion 46 such that the image data is associated with the chart information displayed on the chart information display screen (when the chart information is determined, the image data is stored in the center DB 161 of the data management server 1). Thus it becomes possible to improve operability for acquisition of image data of an inspection image.

In addition, when image data is acquired during a standby state for acquisition of image data of an inspection image, the inspection image is displayed on the inspection image display screen based on the acquired image data. Thus a user can refer to the inspection image.

The explanation of an embodiment above explained is an example of a medical information processing device according to the present invention and not intended to limit the invention. A detailed structure or detailed functions of the medical information processing device can be modified within the gist of the invention.

According to an embodiment above explained, for example, the chart information display screen 81 and the inspection image display screen 82 are included in one screen (medical information display screen 431, 432 or 433). However, the chart information display screen 81 and the inspection image display screen 82 may be displayed in respective windows or respective monitors.

According to an embodiment above explained, the terminal device 4A acquired image data of an inspection image from the inspection equipment 5A. However, the terminal device 4A, 4B, or the like need not acquire image data of an inspection image directly from the inspection equipment 5A, 5B, or the like but may acquire through another equipment.

In an exemplary embodiment, a HDD or a nonvolatile memory was used, an example, as a computer readable medium for storing a program of the present invention. However, the invention is not limited to the examples. For example, a portable memory medium such as a CD-ROM may be used as a computer readable medium. Furthermore, carrier wave may be used as a medium for providing program data of the invention through a communication line.

According to an aspect of an exemplary embodiment of the present invention, provided is a medical information processing device including a display portion which displays a chart information display screen, an operation portion for specifying an inspection item on the chart information display screen, an acquisition portion which acquires image data of an inspection image corresponding to the specified inspection item, and a controlling portion.

The controlling portion can set the acquisition portion in a standby state for acquisition of the image data when the inspection item is specified by the operation portion. When the image data was acquired by the acquisition portion, the controlling portion can store the acquired image data in a memory portion such that the image data is associated with chart information displayed on the chart information display screen.

According to the medical information processing device, it becomes possible to improve operability when image data of a medical inspection image is acquired.

Preferably, when the image data was acquired by the acquisition portion, the controlling portion of the medical information processing device can display an inspection image on the display portion based on the acquired image data.

The present U.S. application claims a priority under the Paris Convention of Japanese Patent Application No. 2011-249244 filed on Nov. 15, 2011, the disclosure of which is incorporated by reference in its entirety.

What is claimed is:

1. A medical information processing device comprising:
a display portion which displays a chart information display screen,
an operation portion for specifying an inspection item on the chart information display screen,
an acquisition portion which acquires image data of an inspection image corresponding to the specified inspection item, and
a controlling portion, wherein;
the controlling portion sets the acquisition portion in a standby state for acquisition of the image data when the inspection item is specified by the operation portion, and
when the image data was acquired by the acquisition portion, the controlling portion stores the acquired image data in a memory portion such that the image data is associated with chart information being displayed on the chart information display screen.

2. The medical information processing device according to claim 1, wherein;
when the image data was acquired by the acquisition portion, the controlling portion displays an inspection image on the display portion based on the acquired image data.
